(19) United States
(12) Patent Application Publication
(10) Pub. No.: US 2016/0084719 A1
(43) Pub. Date: Mar. 24, 2016

(54) STRAIN-FREE SENSOR

(71) Applicant: Jonas A. Ivasauskas, Blacksburg, VA (US)

(72) Inventor: Jonas A. Ivasauskas, Blacksburg, VA (US)

(73) Assignee: BAKER HUGHES INCORPORATED, Houston, TX (US)

(21) Appl. No.: 14/490,032

(22) Filed: Sep. 18, 2014

(51) Int. Cl. G01K 11/32; B29C 47/00; B29C 47/02

(52) U.S. Cl. CPC G01K 11/32; B29C 47/025; B29C 47/0026; B29K 2071/00

(57) ABSTRACT

A strain-free sensor includes a conductor extending from a first end to a second end through an intermediate portion. The conductor has a first coefficient of thermal expansion. A coating is bonded to the intermediate portion of the conductor. The coating has a second coefficient of thermal expansion that is distinct from the first coefficient of thermal expansion. A tube is disposed about the conductor. The tube includes an inner surface provided with a plurality of projections. The conductor is slidingly arranged within the tube with the plurality of projections being configured and disposed to establish a substantially friction-free interface between the tube and the conductor forming the strain-free sensor.

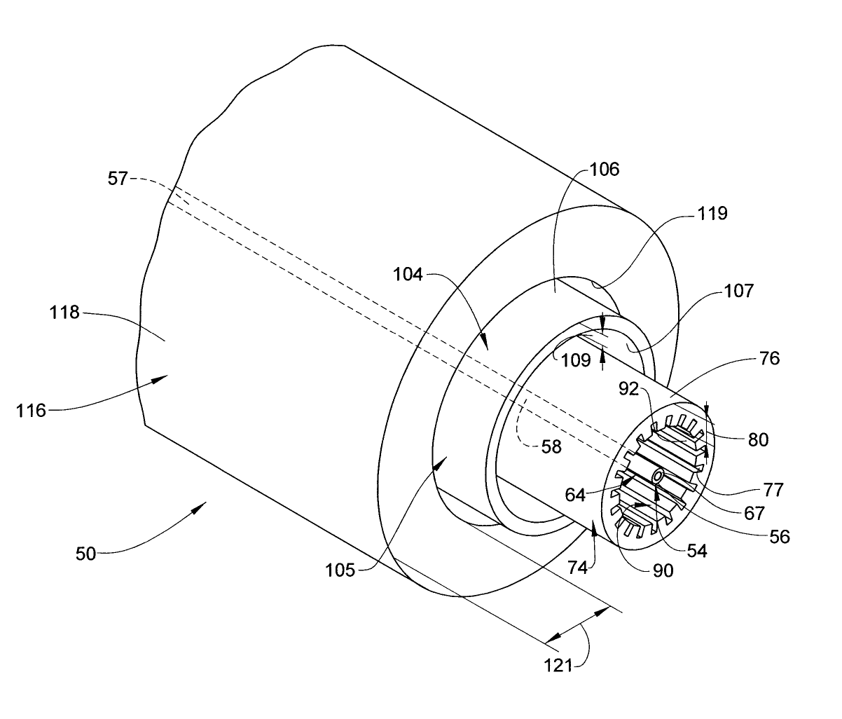

### BACKGROUND

The present invention pertains to the art of sensors and, more particularly, to a strain free fiber optic sensor.

Sensing systems utilize various conductors to detect a multitude of parameters. Conductors may be used to detect strain, stress, temperature, and the like. Fiber optic conductors are often used to detect temperature in a downhole environment. Long lengths of fiber optic conductor often extend from an uphole data acquisition system downhole alongside drilling and production tubing to detect temperatures of drilling and production fluids. The conductors are generally disposed within a protective covering.

### SUMMARY

A strain-free sensor includes a conductor extending from a first end to a second end through an intermediate portion. The conductor has a first coefficient of thermal expansion. A coating is bonded to the intermediate portion of the conductor. The coating has a second coefficient of thermal expansion that is distinct from the first coefficient of thermal expansion. A tube is disposed about the conductor. The tube includes an inner surface provided with a plurality of projections. The conductor is slidingly arranged within the tube with the plurality of projections being configured and disposed to establish a substantially friction-free interface between the tube and the conductor forming the strain-free sensor.

A method of forming a strain-free sensor includes covering a conductor with a coating having a coefficient of thermal expansion that differs from a coefficient of thermal expansion of the conductor, and arranging the conductor covered with the coating within a tube having an inner surface including a plurality of projections that establish a substantially friction-free interface with the conductor.

### BRIEF DESCRIPTION OF THE DRAWING

Referring now to the drawing wherein like elements are numbered alike in the Figure:

The FIGURE depicts a partial perspective view of a strain-free conductor in accordance with an exemplary embodiment.

### DETAILED DESCRIPTION

A strain-free sensor, in accordance with an exemplary embodiment, is indicated generally at 50, in the figure. Strain-free sensor 50 includes an inner sensing conductor 54 that extends from a first end 56 to a second end 57 through an intermediate portion 58. Inner sensing conductor 54 includes a coefficient of thermal expansion. The coefficient of thermal expansion is dependent on the particular material forming inner sensing conductor 54. Inner sensing conductor 54 is covered with a coating 64. Coating 64 includes a coefficient of thermal expansion that differs from the coefficient of thermal expansion of the inner sensing conductor 54.

In accordance with one aspect of an exemplary embodiment, coating 64 may take the form of a Perfluoroalkoxy alkane (PFA) coating. In accordance with another aspect of an exemplary embodiment, coating 64 may take the form of a Polyether-ether-ketone (PEEK) coating. Of course, it should be understood that coating 64 may take on other forms. Coating 64 is overlaid onto, and bonded with, intermediate portion 58. In accordance with an aspect of an exemplary embodiment coating 64 has a thickness 67 of between about 0.00535″ (0.1358-mm) and about 0.001″ (0.0254-mm). In accordance with another aspect of an exemplary embodiment, thickness 67 is about 0.003-inch (0.0762-mm)

A tube 74, which in accordance with an aspect of an exemplary embodiment, is formed from PEEK is disposed about inner sensing conductor 54 and coating 64. Tube 74 includes an outer surface 76 and an inner surface 77 that define a thickness 80. In accordance with an aspect of an exemplary embodiment, coating 64 has a thickness 80 of between about 0.005″ (0.127-mm) and about 0.020″ (0.508-mm). In accordance with another aspect of an exemplary embodiment, thickness 80 is about 0.010″ (0.254-mm) Tube 74 is extruded over inner sensing conductor 54 and coating 64.

At this point it should be understood that the term “strain-free” describes a substantially friction-free interface between an inner sensing conductor 54 and tube 74. The substantially friction-free interface reduces sensor artifacts that may adversely affect environmental conditions perceived by the inner sensing conductor 54. Inner surface 77 includes a plurality of projections 90 that are shown in the form of longitudinal ridges 92. Of course, it should be understood that the particular geometry of projections 90 may vary. Projections 90 reduce a contact surface area between coating 64 and inner surface 77. The reduced contact area coupled with material properties of coating 64, substantially reduces frictional forces between inner sensing conductor 54 and tube 74.

In further accordance with an exemplary embodiment, an armored covering 104 is disposed about tube 74. Armored covering 104 may take the form of a fiber in metal tube (FIMT) 105 having an outer surface 106 and an inner surface 107. In accordance with an aspect of an exemplary embodiment, outer surface 106 includes a diameter of about 0.125-inch (3.175-mm) and inner surface 107 includes a diameter of about 0.109-inch (2.769-mm) defining a thickness 109 of about 0.008″ (0.203-mm).

In still further accordance with an exemplary embodiment, a metal tube 116 is fabricated about armored covering 104. Metal tube 116 includes an outer surface 118 and an inner surface 119. In accordance with an aspect of an exemplary embodiment, metal tube 116 may be formed from stainless steel. Of course, metal tube 116 may be formed from other materials as well, depending upon environmental conditions for strain-free sensor 50. In accordance with another aspect of an exemplary embodiment, outer surface 118 includes a diameter of about 0.250-inch (6.350-mm) and inner surface 119 includes a diameter of about 0.201-inch (5.105-mm) defining a thickness 121 of about 0.049″ (1.245-mm) It should be understood that metal tube 116 may be fabricated about tube 74 without the use of armored covering 104.

At this point it should be understood that the exemplary embodiment describes a strain-free conductor that includes a substantially friction-free interface between an inner sensing conductor and a surrounding protective tube. In this manner, the inner sensing conductor remains free of artifacts that may be induced by stress or strain. Therefore, the exemplary embodiment is particularly suited for sensing in a downhole environment in which long runs of sensing conductor are utilized. The strain-free sensor, in accordance with exemplary embodiment, enables more accurate sensing of downhole conditions without the need to account for sensing artifacts that may be induced by stress or strain.

While one or more embodiments have been shown and described, modifications and substitutions may be made thereto without departing from the spirit and scope of the invention. Accordingly, it is to be understood that the present invention has been described by way of illustrations and not limitation.

1. A strain-free sensor comprising:
a conductor extending from a first end to a second end through an intermediate portion, the conductor having a first coefficient of thermal expansion;
a coating bonded to the intermediate portion of the conductor, the coating having a second coefficient of thermal expansion that is distinct from the first coefficient of thermal expansion; and
a tube disposed about the conductor, the tube including an inner surface provided with a plurality of projections, wherein the conductor is slidingly arranged within the tube with the plurality of projections being configured and disposed to establish a substantially friction-free interface between the tube and the conductor forming the strain-free sensor.

2. The strain-free sensor according to claim 1, wherein the coating is formed from Polyether Ether Ketone (PEEK).

3. The strain-free sensor according to claim 1, wherein the coating includes a thickness of between about 0.00535″ (0.1358-mm) and about 0.003″ (0.0762-mm).

4. The strain-free sensor according to claim 1, wherein the PFA coating includes a thickness of about 0.003-inch (0.0762-mm).

5. The strain-free sensor according to claim 1, wherein the tube includes a thickness of between about 0.005″ (0.127-mm) and about 0.020″ (0.508-mm).

6. The strain-free sensor according to claim 1, wherein the tube is formed from perfluoroalkoxy alkane (PFA).

7. The strain-free sensor according to claim 1, further comprising: a metal tube disposed about the tube.

8. The strain-free sensor according to claim 7, wherein the metal tube includes an outer surface having a diameter of about 0.250-inch (6.350-mm) and an inner surface having a diameter of about 0.201-inch (5.105-mm).

9. The strain-free sensor according to claim 1, further comprising: an armored covering disposed about the tube.

10. The strain-free sensor according to claim 9, wherein armored covering includes an outer surface having a diameter of about 0.125-inch (3.175-mm) and an inner surface having a diameter of about 0.109-inch (2.769-mm).

11. The strain-free sensor according to claim 1, further comprising:
an armored covering disposed about the tube; and
a metal tube disposed about the armored covering.

12. The strain-free sensor according to claim 1, wherein the strain-free sensor is configured for use in a downhole environment.

13. The strain-free sensor according to claim 1, wherein the conductor is a fiber optic conductor.

14. The strain-free sensor according to claim 13, wherein the plurality of projections extend longitudinally along the inner surface of the tube.

15. A method of forming a strain-free sensor, the method comprising:
covering a conductor with a coating having a coefficient of thermal expansion that differs from a coefficient of thermal expansion of the conductor; and
arranging the conductor covered with the coating within a tube having an inner surface including a plurality of projections that establish a substantially friction-free interface with the conductor.

16. The method of claim 15, wherein covering the conductor with the coating includes covering the conductor with Polyether-ether-ketone (PEEK).

17. The method of claim 15, wherein arranging the conductor with the coating within a tube includes arranging the conductor with the coating in a tube formed from perfluoroalkoxy alkane (PFA).

18. The method of claim 15, wherein arranging the conductor covered in the coating in the tube includes extruding the tube formed from PEEK over the conductor covered in the coating.

19. The method of claim 15, further comprising: covering the tube with an armored coating.

20. The method of claim 13, further comprising: fabricating a metal tube about the tube.
